(19) United States
(12) Patent Application Publication
(10) Pub. No.: US 2024/0215097 A1
(43) Pub. Date: Jun. 27, 2024

(54) METHOD FOR SUPPORTING SMALL DATA TRANSMISSION IN CONSIDERATION OF MOBILITY OF TERMINAL IN SEPARATE BASE STATION

(71) Applicant: Samsung Electronics Co., Ltd., Suwon-si, Gyeonggi-do (KR)

(72) Inventors: Jinwoo OCK, Suwon-si (KR); Beomsik BAE, Suwon-si (KR)

(21) Appl. No.: 18/288,920

(22) PCT Filed: May 3, 2022
(86) PCT No.: PCT/KR2022/006344

§ 371 Date: Oct. 30, 2023

(30) Foreign Application Priority Data
May 10, 2021 (KR) 10-2021-0059937

(51) Int. Cl. H04W 76/19; H04W 76/20; H04W 76/30

(52) U.S. Cl. CPC H04W 76/19; H04W 76/20; H04W 76/30

(57) ABSTRACT

The disclosure relates to a 5G or 6G communication system for supporting a higher data transmission rate. According to an embodiment of the disclosure, a method of a first base station may be provided, the method comprising the steps of: receiving a radio resource control (RRC) resume message for small data transmission (SDT) from an RRC inactive terminal; transmitting a first message for requesting of a terminal context to a second base station, wherein the first message includes an SDT indicator; in case that the terminal context is not relocated for the SDT, receiving a second message including partial information of the entire context of the terminal, which is included in the second base station; and based on the partial information of the second message, transferring uplink data of the terminal to the second base station.

### CROSS-REFERENCE TO RELATED APPLICATION(S)

This application is a U.S. National Stage application under 35 U.S.C. § 371 of an International application number PCT/KR2022/006344, filed on May 3, 2022, which is based on and claims priority of a Korean application number 10-2021-0059937, filed on May 10, 2021, in the Korean Intellectual Property Office, the disclosure of which is incorporated by reference herein in its entirety.

### TECHNICAL FIELD

The disclosure relates to the operations of a terminal and base station in a wireless communication system. In addition, the disclosure relates to a method and device for supporting small data transmission in consideration of the mobility of a terminal in a separate base station.

### BACKGROUND ART

5^{th} generation (5G) mobile communication technologies define broad frequency bands to provide higher transmission rates and new services, and can be implemented in “Sub 6 GHz” bands such as 3.5 GHz, and also in “above 6 GHz” bands, which may be referred to as mmWave bands including 28 GHz and 39 GHz. In addition, the implementation of 6^{th} generation (6G) mobile communication technologies, which may be called a beyond 5G system, in terahertz bands (e.g., 95 GHz to 3THz bands) has been considered in order to achieve transmission rates fifty times faster than 5G mobile communication technologies and ultra-low latencies one-tenth of 5G mobile communication technologies.

In the beginning of 5G mobile communication technologies, in order to support services and to satisfy performance requirements in connection with enhanced mobile broadband (eMBB), ultra-reliable low-latency communications (URLLC), and massive machine-type communications (mMTC), there had been ongoing standardization regarding beamforming and massive multi-input multi-output (MIMO) for mitigating radio-wave path loss and increasing radio-wave transmission distances in mmWave, supporting various numerologies (e.g., operating a plurality of subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding locations and states of vehicles transmitted by the vehicles and for enhancing user convenience, new radio (NR)-Unlicensed (U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE locations.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (MLE), Al service support, metaverse service support, drone communication, and the like.

In addition, such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and artificial intelligence (AI) from the design stage and internalizing end-to-end Al support functions, and next-generation distributed computing technologies for implementing services at levels of complexity exceeding the limit of UE operation capability by utilizing ultra-high-performance communication and computing resources.

### DISCLOSURE OF INVENTION

### Technical Problem

The technical problem to be solved in the embodiments of the disclosure is to provide improved operation of the base station and terminal. In addition, the technical problem to be solved in the embodiments of the disclosure is to provide a method and device for supporting small data transmission in consideration of the mobility of the terminal in a separate base station.

### Solution to Problem

An embodiment of the disclosure may provide a method of a first base station, which comprises receiving a radio resource control (RRC) resume message for small data transmission (SDT) from a terminal in an RRC inactive, transmitting a first message for requesting of a terminal context to a second base station, wherein the first message includes an SDT indicator, in case that the terminal context is not relocated for the SDT, receiving a second message including partial information of an entire context of the terminal, which is included in the second base station, and based on the partial information of the second message, transferring uplink data of the terminal to the second base station.

In addition, an embodiment of the disclosure may provide a method of a second base station, comprising receiving a first message for requesting a terminal context from a first base station, wherein the first message includes a small data transmission (SDT) indicator for SDT of a terminal in a radio resource control (RRC) inactive; based on the first message, determining whether to relocate the terminal context; in case that the terminal context is not relocated for the SDT, transmitting a second message including partial information of an entire context of the terminal, which is included in the second base station, to the first base station; and in case that the terminal context is relocated for the SDT, transmitting a third message including the entire context of the terminal, which is included in the second base station, to the first base station.

In addition, an embodiment of the disclosure may provide a first base station, comprising a transceiver; and a controller configured to receive a radio resource control (RRC) resume message for small data transmission (SDT) from a terminal in an RRC inactive; transmit a first message for requesting of a terminal context to a second base station, wherein the first message includes an SDT indicator; in case that the terminal context is not relocated for the SDT, receive a second message including partial information of an entire context of the terminal, which is included in the second base station; and based on the partial information of the second message, transfer uplink data of the terminal to the second base station.

In addition, an embodiment of the disclosure may provide a second base station, comprising a transceiver; and a controller configured to receive a first message for requesting a terminal context from a first base station, wherein the first message includes a small data transmission (SDT) indicator for SDT of a terminal in a radio resource control (RRC) inactive; based on the first message, determine whether to relocate the terminal context; in case that the terminal context is not relocated for the SDT, transmit a second message including partial information of an entire context of the terminal, which is included in the second base station, to the first base station; and in case that the terminal context is relocated for the SDT, transmit a third message including the entire context of the terminal, which is included in the second base station, to the first base station.

Technical problems to be solved in an embodiments of the disclosure are not limited to the above technical problems, and other technical problems not mentioned will be clearly understood by those having ordinary knowledge in the technical field to which the disclosure pertains from the following description.

### Advantageous Effects of Invention

Various embodiments of the disclosure may provide the improved operations of a base station and terminal. In addition, various embodiments of the disclosure may provide a method and device for supporting small data transmission in consideration of the mobility of the terminal in a separate base station.

### BRIEF DESCRIPTION OF DRAWINGS

FIG. 1 is a diagram illustrating an example of a next-generation mobile communication system structure.

FIG. 2 is a diagram illustrating a wireless protocol structure of a next-generation mobile communication system.

FIG. 3 is a diagram illustrating radio access status transition in a next-generation mobile communication system, according to an embodiment of the disclosure.

FIG. 4 is a sequence diagram illustrating a process in case that a UE connected to a separate base station switches to an inactive radio access state in a next-generation mobile communication system, according to an embodiment of the disclosure.

FIG. 5 is a diagram illustrating a structure and tunnel constitution of a separate base station for supporting a first method for transmitting small data (SD) transmitted by a UE in an inactive mode to a user plane, according to an embodiment of the disclosure.

FIGS. 6A and 6B are diagrams illustrating in detail procedures between a UE and a separate base station, and inside the separated base station, according to an embodiment of the disclosure.

FIGS. 7A, 7B, 7CA, 7CB, and 7D are diagrams illustrating in detail the messages and information elements (IEs) newly defined in the procedure described in relation to FIGS. 6A and 6B.

FIG. 8 is a diagram illustrating a structure of a UE according to an embodiment of the disclosure.

FIG. 9 is a diagram illustrating a structure of a base station according to an embodiment of the disclosure.

### MODE FOR THE INVENTION

Hereinafter, embodiments of the disclosure will be described in detail with reference to the accompanying drawings.

In describing the embodiments, a description of techniques known to those skilled in the art and not directly related to the disclosure may be omitted. Such unnecessary omission of description is intended to prevent obscuring the main concepts of the disclosure and to more clearly convey the main concepts.

For the same reason, in the accompanying drawings, some components may be exaggerated, omitted, or schematically illustrated. Further, the size of each component does not entirely reflect the actual size. In the drawings, identical or corresponding components are provided with identical reference numerals.

Advantages and features of the disclosure and the manner of attaining them will become apparent by reference to the following detailed description of embodiments when taken in conjunction with the accompanying drawings. However, the disclosure is not limited to the embodiments described below, but may be implemented in various different forms. The embodiments are provided solely to complete the disclosure and to inform those skilled in the art to which the disclosure pertains of the full scope of the disclosure. The disclosure is to be limited only by the scope of the following claims. Throughout the specification, the same or similar reference numerals denote the same or similar components.

Here, it will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block(s). These computer program instructions may also be stored in a computer-usable or computer-readable memory that can direct a computer or other programmable data processing apparatus to function in a particular manner, such that the instructions stored in the computer-usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions which execute on the computer or other programmable data processing apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that, in some alternative implementations, the functions noted in the blocks may occur out of the order. For example, two blocks shown in succession may, in fact, be executed substantially concurrently, or the blocks may sometimes be executed in the reverse order, depending upon the functionality involved.

In the following description, terms for identifying an access node, terms for with reference to network entities, terms for with reference to messages, terms for with reference to interfaces between network entities, terms for with reference to various identification information, and the like are illustratively used for convenience. Accordingly, the disclosure is not limited by the terms used below, and other terms with reference to the subject matter having an equivalent technical meaning may be used.

In the disclosure, for convenience of description, the disclosure uses terms and names defined in standards regarding 5G, new radio (NR), or long term evolution (LTE) systems. However, the disclosure is not limited by such terms and names, and may be equally applied to systems complying with other standards. In the disclosure, terms such as eNB, LTE enB, gNB, and NR gNB can be used with the same meaning as a term, a base station, and a UE can be used with the same meaning as terms such as terminal and mobile device.

That is, while a description will be focused on a communication standard specified by the 3GPP, when embodiments of the disclosure are described in detail, a main subject matter of the disclosure is also applicable to other communication systems having a similar technical background with slight modifications without significantly departing from a scope of the invention, as will be possible at the discretion of a person skilled in the technical field of the disclosure.

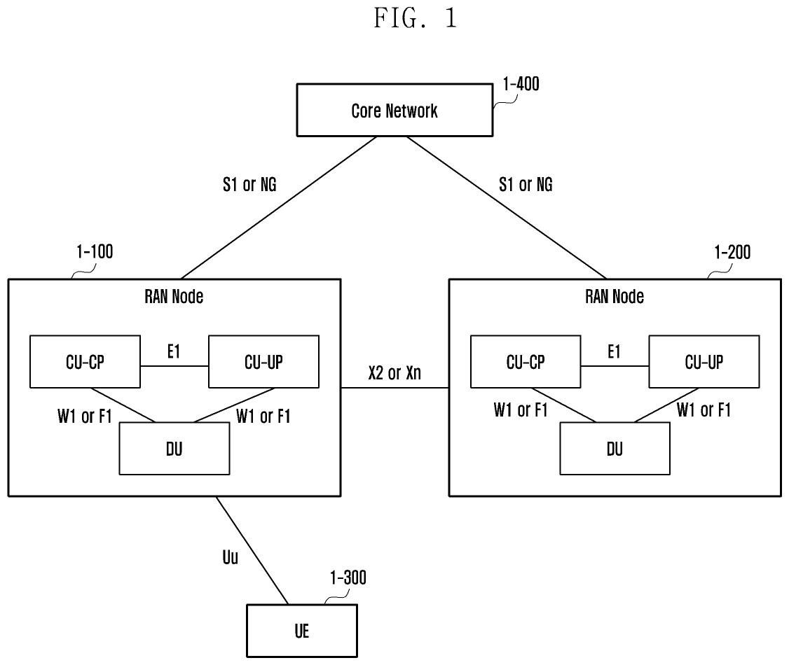

FIG. 1 is a diagram illustrating an example of a next-generation mobile communication system structure. That is, FIG. 1 illustrates an example of a next-generation mobile communication system structure to which the embodiments of the disclosure may be applied.

With reference to FIG. 1, a radio access network (RAN) Node 1-100 or 1-200 specified in this structure may refer to a mobile communication base station such as an LTE evolved node B (eNB, eNodeB) or a next generation node B (NR gNB, gNodeB) connected to a mobile communication core network such as evolved packet core (EPC) or a 5G core network (5GC) 1-400. In addition, the RAN node 1-100 or 1-200 may be divided into a centralized unit (CU) and a distributed unit (DU), and the CU may be divided again into a CU-control plane (CP) and a CU-user plane (UP).

According to an embodiment, one RAN node may be constituted with one or more CU-CPs, one or more CU-UPs, and one or more DUs. In addition, a CU-CP, a CU-UP, and a DU constituting one RAN node may be constituted together. For example, one RAN node may be constituted with a CU, in which a CU-CP and a CU-UP are implemented together, and a DU. In another example of one RAN node, a CU-CP and a DU may be implemented together, and a CU-UP may be constituted separately. Another example of RAN Node may be constituted in the form of an integrated base station in which a CU-CP, a CU-UP, and a DU are implemented together. One RAN node may also be constituted with any other combination than the above-described examples.

According to an embodiment, a CU and a DU may respectively support base station functions that are different from each other. For example, a CU may support a radio resource control (RRC)/packet data convergence protocol (PDCP) layer, and a DU may support a radio link control (RLC)/medium access control (MAC)/physical layer (PHY)/radio frequency (RF) layer. In addition, the CU and the DU may be connected to each other through an interface between functions within a base station, such as a W1 or F1 interface.

According to an embodiment, a CU may be divided into a CU-CP and a CU-UP. For example, a RRC/PDCP (for RRC) layer may be supported in a CU-CP, a PDCP (for user data transmission) layer may be supported in a CU-UP, and the CU-CP and the CU-UP may be connected to each other through an interface between functions within a base station, such as an E1 interface.

According to an embodiment, base stations may be in an integrated structure or a separate structure, such that connection between integrated structure base stations, between separate base stations, or between an integrated structure base station and a separate structure base station may be made. RAN nodes may be connected to each other via an interface between base stations, such as an X2 or Xn interface. In addition, a RAN node and a core network may be connected through an interface between a base station and a core network, such as an S1 or NG Interface. The technology proposed in the disclosure may be applied to a case where the terminal 1-300 connects to an integrated or separate RAN node to transmit small data while maintaining an inactive (RRC_INACTIVE) radio access state.

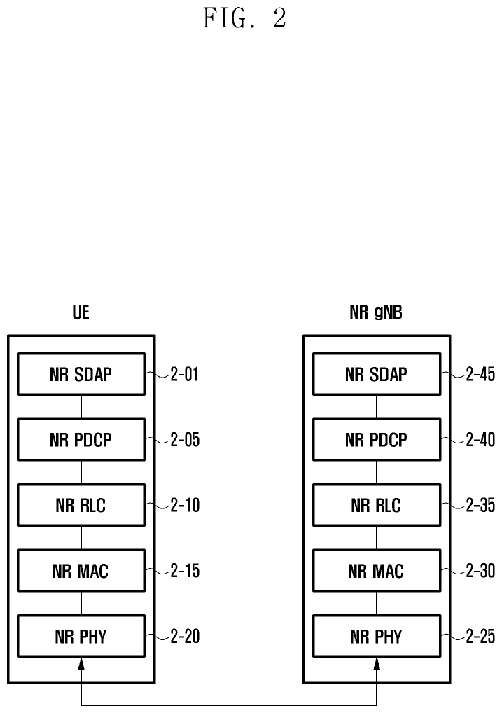

FIG. 2 is a diagram illustrating a wireless protocol structure of a next-generation mobile communication system. That is, FIG. 2 is a diagram illustrating a wireless protocol structure of a next-generation mobile communication system to which the embodiments of the disclosure may be applied.

With reference to FIG. 2, in each of a terminal and an NR base station (e.g., NR gNB), a wireless protocol of the next-generation mobile communication system may be constituted with an NR service data adaptation protocol (SDAP) 2-01 or 2-45, an NR PDCP 2-05 or 2-40, an NR RLC 2-10 or 2-35, an NR MAC 2-15 or 2-30, and an NR PHY 2-20 or 2-25.

The major functions of the NR SDAP layer 2-01 or 2-45 may include some of functions below.
Transfer function of user data (transfer of user plane data)
Mapping function between a quality of service (QoS) flow and a data bearer for both UL and DL (mapping between a QoS flow and a DRB (data radio bearer) for both DL (downlink) and UL (uplink))
Marking function of QoS flow ID in both UL and DL(marking Qos flow ID in both DL and UL packets)
Mapping function of reflective QoS flow to data bearer for the UL SDAP protocol data units (PDUs) (reflective QoS flow to DRB mapping for the UL SDAP PDUs).

With respect to an SDAP layer entity, a terminal may be configured to determine whether to use a header of the SDAP layer entity or to use functions of the SDAP layer entity, via a radio resource control (RRC) message, for each PDCP layer entity, each bearer, or logical channel. In case that the SDAP header is configured, a 1-bit non-access stratum (NAS) reflective QoS configuration indicator and a 1-bit access stratum (AS) reflective QoS configuration indicator of the SDAP header may indicate to the UE to update or reconfigure mapping information between a QoS flow and a data bearer for both UL and DL. The SDAP header may include QoS flow ID information indicating a QoS. QoS information may be used as data processing priority, scheduling information, or the like, to support proper provision of services.

The major functions of the NR PDCP 2-05 or 2-40 may include some of functions below.
Header compression and decompression functions (Header compression and decompression: ROHC only)
Transfer function of user data
In-sequence delivery function (In-sequence delivery of upper layer PDUs)
Out-of-sequence delivery function (Out-of-sequence delivery of upper layer PDUs)
Reordering function (PDCP PDU reordering for reception)
Duplication detection function (Duplicate detection function of lower layer SDUs)
Retransmission function (Retransmission of PDCP SDUs)
Ciphering and deciphering functions
Timer-based SDU discard function (Timer-based SDU discard in uplink.)

In the above description, the reordering function of the NR PDCP entity may mean a function of reordering PDCP PDUs received in a lower layer in order based on PDCP sequence numbers (SN). The reordering function of the NR PDCP entity may include a function of delivering data to an upper layer in a reordered order. Alternatively, the reordering function of the NR PDCP entity may include a function of directly transferring data without considering the order. In addition, the reordering function of the NR PDCP entity may have a function of reordering the order and recording lost PDCP PDUs, and may include a function of reporting status of the lost PDCP PDUs to a transmitting side, and requesting retransmission of the lost PDCP PDUs.

The major functions of the NR RLC 2-10 or 2-35 may include some of functions below.
Data transfer function (Transfer of upper layer PDUs)
In-sequence delivery function (In-sequence delivery of upper layer PDUs)
Out-of sequence delivery function (Out-of-sequence delivery of upper layer PDUs)
ARQ function (Error Correction through ARQ)
Concatenation, segmentation and reassembly functions (Concatenation, segmentation and reassembly of RLC SDUs)
Re-segmentation function (Re-segmentation of RLC data PDUs)
Reordering function (Reordering of RLC data PDUs)
Duplicate detection function
Error detection function (Protocol error detection)
RLC SDU discard function
RLC re-establishment function

In the above description, an in-sequence delivery function of an NR RLC entity may mean a function of transferring RLC SDUs received from a lower layer to an upper layer in order. In case that an originally single RLC SDU is received after being divided into multiple RLC SDUs, the in-sequence delivery function of the NR RLC entity may include a function of reassembling the RLC SDUs and delivering the same.

The in-sequence delivery function of the NR RLC entity may include a function of reordering the received RLC PDUs based on RLC sequence numbers (SNs) or PDCP sequence numbers (SNs). Also, the in-sequence delivery function of the NR RLC entity may include a function of reordering the order and recording lost RLC PDUs. Also, the in-sequence delivery function of the NR RLC entity may have a function of reporting status of the lost RLC PDUs to a transmitting side, and may include a function of requesting retransmission of the lost RLC PDUs.

In case that there is a lost RLC SDU, the in-sequence delivery function of the NR RLC entity may include a function of delivering only RLC SDUs before the lost RLC SDU, to an upper layer in order.

Even in case that there is a lost RLC SDU, in case that a certain timer has expired, the in-sequence delivery function of the NR RLC entity may include a function of delivering all RLC SDUs received before the timer is started, to an upper layer in order.

Even in case that there is a lost RLC SDU, in case that a certain timer has expired, the in-sequence delivery function of the NR RLC entity may include a function of delivering all RLC SDUs received up to present, to an upper layer in order.

The NR RLC entity may also sequentially process RLC PDUs regardless of an order of sequence numbers but in order of receiving them (out-of sequence delivery) and delivering the same to the NR PDCP entity.

In case that the NR RLC entity receives a segment, segments that are stored in a buffer or that are to be received later may be received and reconstituted as a complete single RLC PDU and this RLC PDU may be delivered to the NR PDCP entity.

The NR RLC layer may not have a concatenation function. Alternatively, a concatenation function may be performed in the NR MAC layer or replaced by a multiplexing function of the NR MAC layer.

In the above description, the out-of-sequence delivery function of an NR RLC entity may mean a function of delivering RLC SDUs received from a lower layer directly to an upper layer regardless of an order. In case that an originally single RLC SDU is divided into multiple RLC SDUs and received, the out-of-sequence delivery function of the NR RLC entity may include a function of reassembling the RLC SDUs and delivering the same. The out-of-sequence delivery function of the NR RLC entity may include a function of storing RLC SNs or PDCP SNs of received RLC PDUs and reordering the RLC PDUs and recording lost RLC PDUs.

The NR MAC 2-15 or 2-30 may be connected to several NR RLC layer entities constituted in a terminal, and the major functions of the NR MAC may include some of functions below.
Mapping function (Mapping between logical channels and transport channels)
Multiplexing and demultiplexing functions (Multiplexing/demultiplexing of MAC SDUs)
Scheduling information reporting function
HARQ function (Error correction through HARQ)
Priority handling function between logical channels (Priority handling between logical channels of one UE)
Priority handling function between UEs (Priority handling between UEs by means of dynamic scheduling)
MBMS service identification function
Transport format selection function
Padding function

The NR PHY layer 2-20 or 2-25 may perform channel coding or modulation on upper layer data and convert the same into an OFDM symbol and transmit the OFDM symbol to a radio channel, or demodulate an OFDM symbol received via a radio channel and perform channel decoding on the demodulated OFDM symbol and deliver the channel-decoded OFDM symbol to an upper layer.

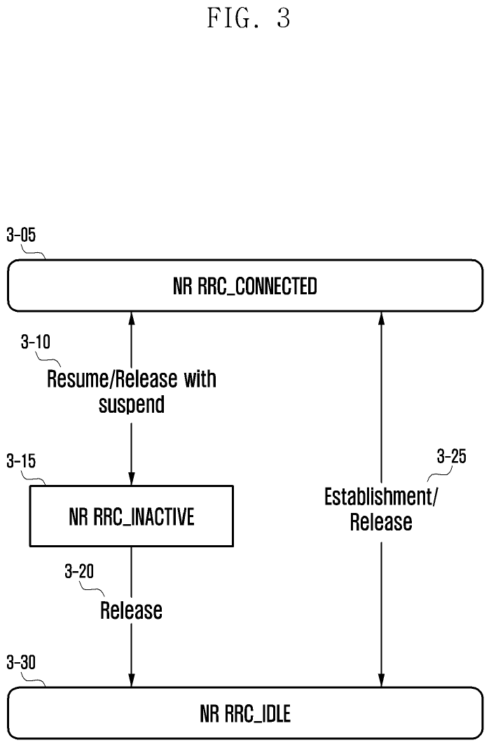

FIG. 3 is a diagram illustrating radio access status transition in a next-generation mobile communication system, according to an embodiment of the disclosure.

The next-generation mobile communication system has three kinds of radio resource control (RRC) states. A connected mode (RRC_CONNECTED) 3-05 may mean to a radio access state where a UE can perform data transmission/reception. An idle mode (RRC_IDLE) 3-30 may mean a radio access state where the UE monitors whether paging is transmitted to itself. The connected mode 3-05 and idle mode are radio access states that also apply to the existing LTE system, and the detailed technology thereof is the same as that of the existing LTE system. In the next-generation mobile communication system, an inactive (RRC_INACTIVE) radio access state 3-15 has been newly defined. In the disclosure, the newly defined RRC_INACTIVE radio access state 3-15 in the next-generation mobile communication system may correspond to inactive radio access state, INACTIVE mode, inactive mode, etc.

In the inactive mode radio access state 3-15, UE context is maintained in the base station and the UE, and RAN-based paging may be supported. The features of the new radio access state are listed as follows.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

According to an embodiment, INACTIVE radio access state 3-15 may be switched to a connected mode 3-05 or idle mode 3-30 by using a specific procedure. In accordance with a resume process, the mode is switched from the INACTIVE mode 3-15 to the connected mode 3-05, and the mode is switched from the connected mode 3-05 to the INACTIVE mode 3-15 by using a release procedure including suspend configuration information 3-10. In the above procedure 3-10, one or more RRC messages are transmitted and received between the UE and the base station, and the above procedure 3-10 may be constituted with one or more operations. Further, the mode may be switched from the INACTIVE mode 3-15 to the idle mode 3-30 through a release procedure after the resume process 3-20.

The transition between the connected mode 3-05 and the idle mode 3-30 follows the existing LTE technology. That is, the transition between the connected mode 3-05 and the idle mode 3-30 may be performed through an establishment or release procedure 3-25.

In order for a UE in the INACTIVE radio access state 3-15 to transmit and receive general data, the UE must be switched to the connected mode 3-05 through the above process 3-10. The method proposed in the disclosure may be applied to a case where the UE transmits small data (SD) while maintaining in an inactive state (without switching to the connected mode). The small data may refer to small-sized data such as, for example, relatively small-capacity message transmission or the user's heart rate in a wearable communication device. Alternatively, as an example, the small data may be defined as data of a size that can be included in one transport block (TB). Alternatively, as an example, the small data may mean data of a size smaller than a preset threshold. In the disclosure, a method for transmitting and receiving small data is described for convenience of understanding, but the scope of the disclosure is not limited by the general meaning of the terms. For example, in case that the data is of a size that may be transmitted and received according to a method described later while the UE maintains in an inactive state without switching to a connected mode, the embodiment proposed in the disclosure may be applied.

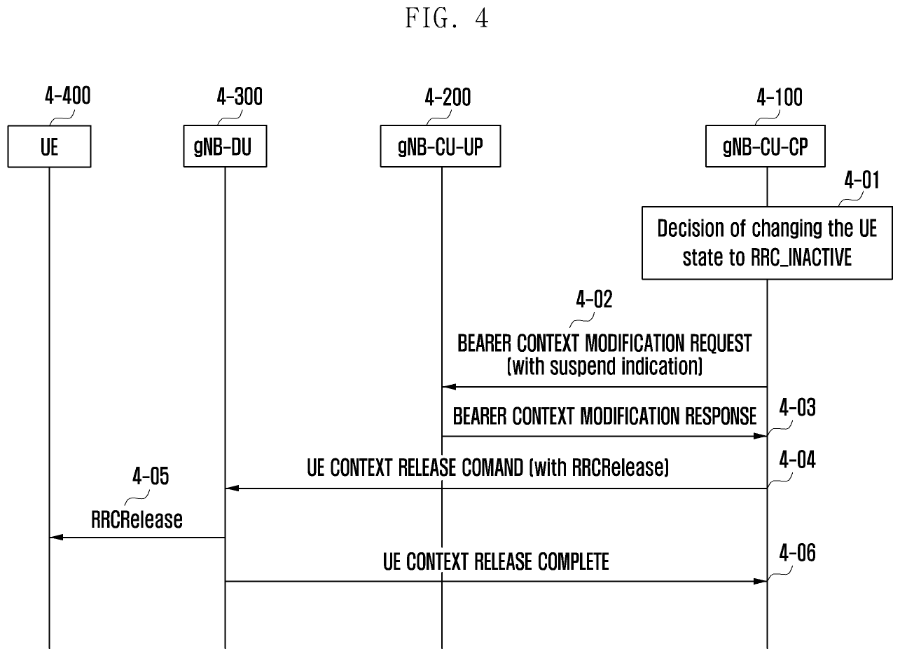

FIG. 4 is a sequence diagram illustrating a process in case that a UE connected to a separate base station switches to an inactive radio access state in a next-generation mobile communication system, according to an embodiment of the disclosure.

In case that the CU-CP 4-100 of a separate base station decides to switch a specific UE 4-400 connected to the corresponding base station to an INACTIVE state (4-01), the CU-CP 4-100 may include a suspend indication in a BEARER CONTEXT MODIFICATION REQUEST message to transmit the same to a CU-UP 4-200 (4-02). The CP-UP 4-200 may transmit BEARER CONTEXT MODIFICATION RESPONSE in response to the message (4-03). In this case, the bearer context for the corresponding UE between the CU-CP 4-100 and the CU-UP 4-200 may be maintained without being removed. The CU-CP 4-100 may transmit a UE CONTEXT RELEASE COMMAND message to the DU 4-300 of the base station to remove the UE context for the corresponding UE (4-04). The DU 4-300 that has received the message transmits an RRCRelease message to the UE 4-400 (4-05) so that the UE 4-400 may transition to the INACTIVE mode. Additionally, the DU 4-300 may notify the CU-CP 4-100 that the UE context has been removed by transmitting a UE CONTEXT RELEASE COMPLETE message (4-06).

After going through the above-described process, the UE may transition to the INACTIVE mode. The separate base station may recognize that the corresponding UE transitioned to the INACTIVE mode while removing the UE context of the corresponding UE that existed between the DU and the CU, and maintaining the bearer context of the corresponding UE that existed between the CU-UP and the CU-CP. The method proposed in the disclosure may be applied to the base station and the UE that has transitioned to the INACTIVE mode through the above-described process.

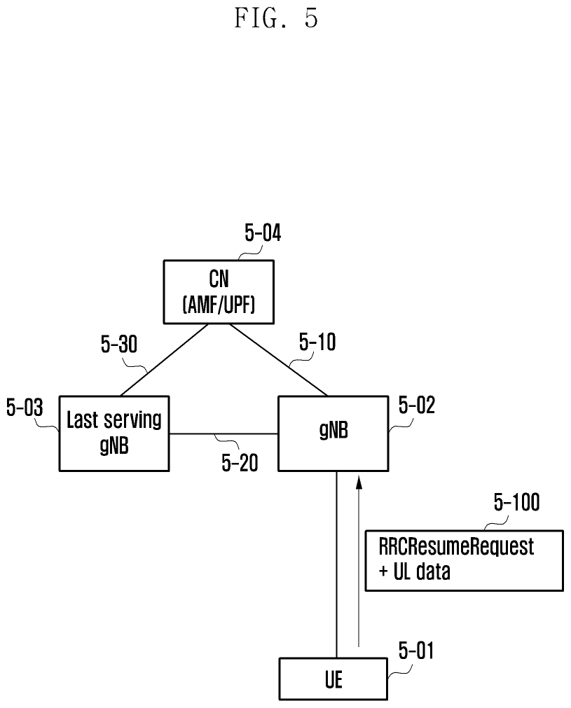

FIG. 5 is a diagram illustrating a process in which a UE 5-01 in an inactive mode moves and transmits small data (SD) through a new gNB 5-02 rather than the last serving gNB 5-03 that has used to exchange data. In this case, the UE Context may be stored in the gNB 5-03 that last exchanged data.

The UE 5-01 in an inactive mode may simultaneously transmit an RRC message (e.g., RRCResumeRequest) and UL data to the new gNB 5-02. In this case, the gNB 5-02 may notify the gNB 5-03 that last exchanged data of the existence of small data transmitted by the UE and request to transfer the UE Context at the same time (for example, the gNB 5-02 may transmit a RETRIEVE UE CONTEXT REQUEST message to a gNB 5-03) (5-20).

In case that the last serving gNB 5-03 with the UE Context receives the above request from the gNB 5-02, the gNB 5-03 may decide whether to use the anchor that transfers small data to a core network (AMF/UPF) 5-04 as a new gNB 5-02 or maintain the existing last serving gNB.

If the last serving gNB 5-03 decides the new gNB 5-02 as the anchor, the last serving gNB 5-03 may transfer the UE Context to the new gNB 5-02 and may transfer the UL data corresponding to small data to the UPF 5-04 through the gNB 5-02 (5-10). Conversely, if the last serving gNB 5-03 decides not to change the anchor, the UL data received by the new gNB 5-02 is transferred to the last serving gNB 5-03 (5-20) and then transferred to the UPF 5-04 (5-30).

As described above, the last serving gNB 5-03 may decide which gNB to use as the anchor, and one of the criteria thereof may be whether to support DL data. In case that the UL data corresponding to small data is received, in case that the DL data exists, the DL data may be transmitted to the UE that transmitted the small data, in response to the reception. This may be supported only in case that the anchor is changed to the new gNB 5-02. Therefore, in case that the last serving gNB 5-03 decides to support the DL data, the anchor may be changed to the new gNB 5-02, and in case that the last serving gNB 5-03 decides not to support the DL data, the anchor may be maintained as the last serving gNB 5-03, and the UL data may be transmitted.

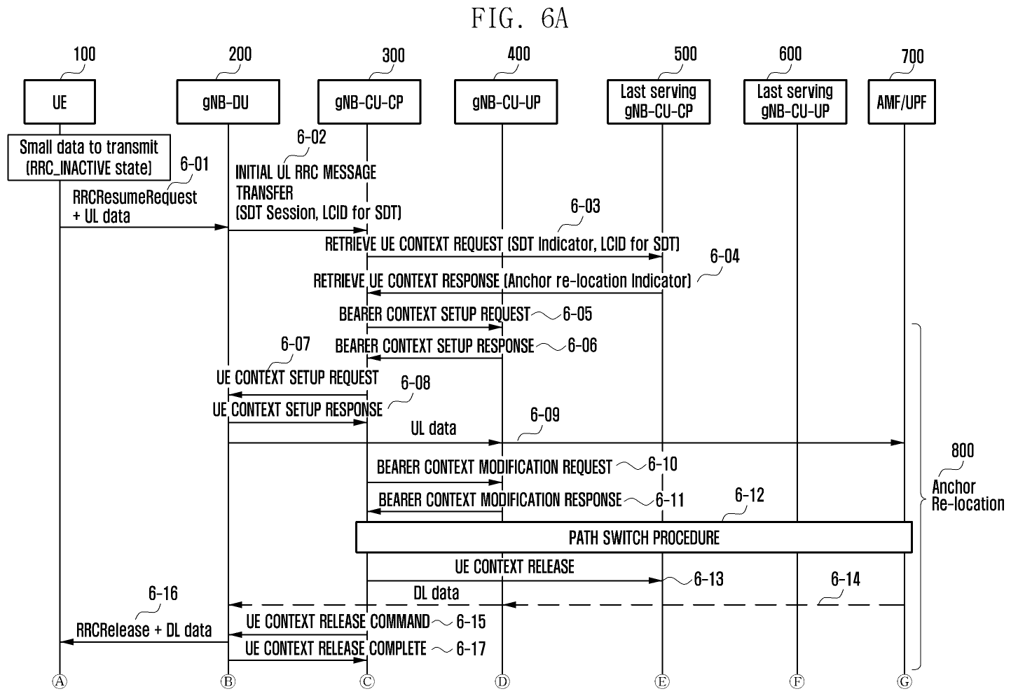

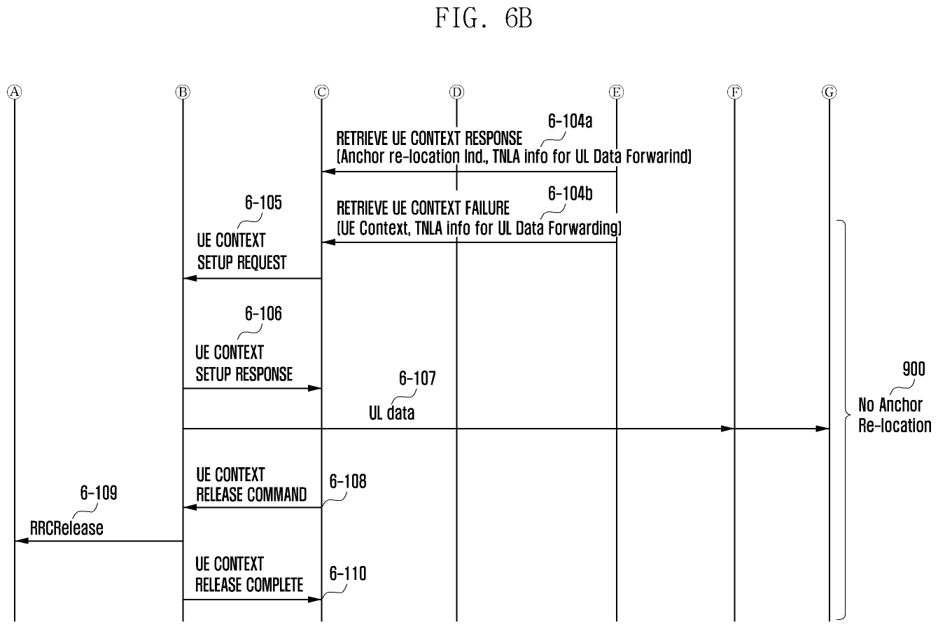

FIGS. 6A and 6B are sequence diagrams illustrating the above description in relation to FIG. 5, along with detailed operations of a separate base station.

In operation 6-01, a UE 100 may simultaneously transmit an RRC message (e.g., RRCResumeRequest message) and UL data to a gNB-DU 200 in order to transmit small data while maintaining an inactive mode (6-01). For example, the UL data may be included in the RRCResumeRequest message to be transmitted, or may be transmitted through separate signaling.

In operation 6-02, the gNB-DU 200 may include the RRCResumeRequest message in a message (e.g., INITIAL UL RRC MESSAGE TRANSFER message) for transferring the RRC message received from the UE 100 to a gNB-CU 300 or 400 and transmit the same to the gNB-CU-CP 300. In this case, the INITIAL UL RRC MESSAGE TRANSFER message may include at least one of an indicator (e.g., SDT Session) indicating that the current operation is for small data transmission (SDT) and a logical channel ID (LCID) used by the UE to transmit the UL data. Meanwhile, the gNB-DU 200 may keep (or store) the UL data received together with the RRCResumeRequest in a buffer without immediately transmitting the UL data.

The gNBs 200, 300, and 400 to which the UE 100 is accessed are the gNBs that are different from the last serving gNBs 500 and 600 that last exchanged data with the UE 100, and the UE context of the corresponding UE 100 may be stored in the last serving gNB-CU-CP 500.

Accordingly, the gNB-CU-CP 300 may request UE Context delivery from the last serving gNB-CP 500 in operation 6-03 (e.g. RETRIEVE UE CONTEXT REQUEST message). The RETRIEVE UE CONTEXT REQUEST message may include at least one of an indicator indicating that it is for small data transmission (SDT) (e.g. SDT Session) and a logical channel ID (LCID) used by the UE to transmit UL data.

The last serving gNB-CU-CP 500, which has received the RETRIEVE UE CONTEXT REQUEST, may decide whether to configure the anchor for exchanging data with the core network (CN) as a new gNB or maintain the existing last serving gNB. According to the decision result, the last serving gNB-CU-CP 500 may proceed with one of an Anchor Re-location procedure 800 and a No Anchor Re-location procedure 900. The decision criterion for whether to perform the Anchor Re-location may be whether to support DL data. In case that there is DL data to be sent to the UE 100 that transmitted the UL data in the SDT operation, this may be supported during the SDT process. Thus, in case of deciding to support the DL data, the last serving gNB-CU-CP 500 may proceed with the Anchor Re-location procedure 800. Conversely, in case of deciding not to support the DL data, the last serving gNB-CU-CP 500 may proceed with one of the Anchor Re-location procedure 800 and the No Anchor Re-location procedure 900.

### <Anchor Re-Location> 800

In case that the last serving gNB-CU-CP 500 decides to proceed with the Anchor re-location procedure, the last serving gNB-CU-CP 500 may transmit a RETRIEVE UE CONTEXT RESPONSE message to the gNB-CU-CP 300 in operation 6-04 in response to the process of 6-03. The RETRIEVE UE CONTEXT RESPONSE message may include UE CONTEXT information about the UE 100 that transmitted small data and an Anchor Re-location Indicator indicating the presence or absence of Anchor re-location. In case that the Anchor Re-location Indicator is present in the RETRIEVE UE CONTEXT RESPONSE message, the procedure 800 may display the corresponding indicator as TRUE to be delivered. In case that the LCID used by the UL 100 to transmit UL data is included in the RETRIEVE UE CONTEXT REQUEST message in operation 6-03, it is possible to select and transmit only the UE CONTEXT corresponding to the DRB that matches the corresponding LCID.

In case that the gNB-CU-CP 300 receives RETRIEVE UE CONTEXT RESPONSE, it may proceed BEARER CONTEXT SETUP operations (6-05 and 6-06) with the gNB-CU-UP 400 by using the UE Context in the corresponding message. After going through this process, the gNB-CU-UP 400 may obtain PDCP configuration information and cell group information of each DRB, and tunnel information with UPF 700 for transmitting the UL data to the CN.

In addition, the gNB-CU-CP 300 may perform the UE CONTEXT SETUP process (6-07 and 08) with the gNB-DU 200, and after performing the process, the UL data stored in the buffer of the gNB-DU 200 may be transmittable.

The UE CONTEXT SETUP REQUEST message 6-07 may include the endpoint address (UL endpoint) of the tunnel through which the gNB-CU-UP 400 may receive UL data. Therefore, the gNB-DU 200 that receives the message may transmit the UL data through the generated tunnel. The UL data transmitted from the gNB-DU 200 may be transferred to the UPF 700 via the gNB-CU-UP 400 (6-09).

In addition, the gNB-DU 200 may transmit a response message (e.g., a UE CONTEXT SETUP RESPONSE message) in response to the UE CONTEXT SETUP REQUEST message to the gNB-CU-CP 300 in operation 6-08. The corresponding UE CONTEXT SETUP RESPONSE message may include the endpoint address (DL endpoint) of the tunnel through which the gNB-DU 200 may receive DL data. Therefore, the gNB-CU-CP 300, which has received the UE CONTEXT SETUP RESPONSE message, may identify the endpoint address.

In operation 6-10, the gNB-CU-CP 300 may transmit a message (e.g., a BEARER CONTEXT MODIFICATION REQUEST message) that is to inform the gNB-CU-UP 400 of tunnel information for the DL data transmission obtained in the operation 6-08 described above. The message may include DL endpoint information, for example.

The gNB-CU-UP 400 may transmit a response message (e.g., a BEARER CONTEXT MODIFICATION RESPONSE message) to the BEARER CONTEXT MODIFICATION REQUEST message to the gNB-CU-CP 300 in operation 6-11.

The gNB-CU-UP 400 may inform the AMF that the DL path to the UE 100 has changed in operation 6-12, and the AMF may inform the UPF of this change so that future DL data can be transmitted to the gNB-CU-UP 400. This may be referred to as PATH SWITCH PROCEDURE 6-12, and in case of omitting this process, the UPF may transmit the DL data destined for the UL 100 to the last serving gNB-CU-UP 600 rather than the gNB-CU-UP 400. Thus, the operation 6-12 may be required to support the DL data transmission.

In case that the gNB-CU-CP 300 has completed the operation 6-12, all necessary UE context information has been acquired and configuration has been completed, so the UE context of the UE 100 stored by the last serving gNB-CU-CP 500 may be indicated to be removed (e.g. UE CONTEXT RELEASE message).

In operation 6-14, the UPF 700 receives the UL data from the gNB-CU-UP 400 and then, in case that there is the DL data destined for the UE 100 that transmitted the corresponding data, the UPF 700 may transmit the DL data to the gNB-CU-UP 400. Alternatively, after the UPF 500 receives the UL data from the gNB-CU-UP 400, in case that there is the DL data destined for the UE 100 that transmitted the corresponding data, the UPF 500 may transmit the DL data to the gNB-CU 400 after a certain period of time. This is because the DL data can be delivered to the gNB-CU-UP 400 only after passing through the operation 6-12 of PATH SWITCH PROCEDURE, and the gNB-CU-UP 400 must obtain the DL endpoint address to deliver the DL data to the gNB-DU 200. How long after the UPF 500 receives the UL data to transmit the DL data may be determined using a timer, etc., and this may depend on the implementation method. In case that there is no DL data to transmit to the UE 100, operation 6-13 may be omitted.

According to an embodiment, in case that there is no DL data destined for the UE 100 or in case that there is no additional DL data after operation 6-14, the gNB-CU-CP 300 may transmit a message to remove the UE context (e.g., a UE CONTEXT RELEASE COMMAND message) to the gNB-DU 200 in operation 6-15.

The gNB-DU 200, which has received the UE CONTEXT RELEASE COMMAND message, may transmit the RRC message (e.g., a RRCRelease message) included in the message to the UE 100 in operation 6-16. In this case, the gNB-DU 200 may transmit the DL data received in the above-described operation 6-14 to the UE 100 along with the RRCRelease message.

In operation 6-17, the gNB-DU 200 may transmit a message (e.g., a UE CONTEXT RELEASE COMPLETE message) to inform the gNB-CU-CP 300 that the UE context has been removed, and the gNB-CU-CP 300 may identify that the UE context has been removed based on the above message.

### <No Anchor Re-Location> 900

In case that the last serving gNB-CU-CP 500 decides not to perform Anchor re-location, one of the following two messages may be transmitted to the gNB-CU-CP 300 in response to the process of 6-03.

### [Method 1]

The last serving gNB-CU-CP 500 may transmit RETRIEVE UE CONTEXT RESPONSE to the gNB-CU-CP 300 in the response to the operation 6-03.

The RETRIEVE UE CONTEXT RESPONSE message may include UE CONTEXT information about the UE 100 that transmitted small data and an Anchor Re-location Indicator indicating the presence or absence of Anchor re-location. In case that the Anchor Re-location Indicator is present in the RETRIEVE UE CONTEXT RESPONSE message, the corresponding indicator may be indicated as FALSE in this procedure 900.

In addition, the RETRIEVE UE CONTEXT RESPONSE message may include UL endpoint information for each DRB of the last serving gNB-CU-UP 600. In case that the anchor re-location is not performed, the UL data sent by the UE 100 must be transferred to the UPF 700 through the last serving gNB-CU-UP 600, and thus the corresponding information is transmitted to the gNB-CU-CP 300, which may be informed to the gNB-DU 200.

### [Method 2]

The last serving gNB-CU-CP 500 may transmit RETRIEVE UE CONTEXT FAILURE to the gNB-CU-CP 300 in response to the operation 6-03.

The RETRIEVE UE CONTEXT FAILURE message may include UE CONTEXT information for the UE 100 that transmitted small data and UL endpoint information for each DRB of the last serving gNB-CU-UP 600. In case that the anchor re-location is not performed, the UL data sent by the UE 100 must be transferred to the UPF 700 through the last serving gNB-CU-UP 600, and thus the corresponding information is transmitted to the gNB-CU-CP 300, which may be informed to the gNB-DU 200.

After performing the operation of Method 1 or Method 2 above, the operations below can be performed.

The gNB-CU-CP 300 may transmit the UL data stored in the buffer of the gNB-DU 200 after going through the UE CONTEXT SETUP process (6-105 and 6-106) with the gNB-DU 200.

The UE CONTEXT SETUP REQUEST message 6-105 may include the endpoint address (UL endpoint) of the tunnel obtained in operation 6-104 through which the last serving gNB-CU-UP 600 can receive UL data. Therefore, the gNB-DU 200 that receives the message may transmit the UL data through the generated tunnel. The UL data transmitted from the gNB-DU 200 may be transferred to the UPF 700 via the last serving gNB-CU-UP 600 (6-107).

In addition, the gNB-DU 200 may transmit a response message (e.g., a UE CONTEXT SETUP RESPONSE message) in response to UE CONTEXT SETUP REQUEST message to the gNB-CU-CP 300 in operation 6-106.

According to an embodiment, the No Anchor Re-location procedure 900 does not support transmission of the DL data destined for the UE 100, so after a certain period of time after the UL data is transmitted to the UPF 700, the gNB-CU-CP 300 may transmit a message (e.g., UE CONTEXT RELEASE COMMAND message) to remove the UE context to gNB-DU 200 in operation 6-108.

The gNB-DU 200, which has received the UE CONTEXT RELEASE COMMAND message, may transmit the RRC message (e.g., a RRCRelease message) included in the message to the UE 100 in operation 6-109.

In operation 6-110, the gNB-DU 200 may transmit a message (e.g., UE CONTEXT RELEASE COMPLETE message) to the gNB-CU-CP 300 to inform the gNB-CU-CP 300 that the UE context has been removed. The gNB-CU-CP 300 may identify that the UE context has been removed based on the message.

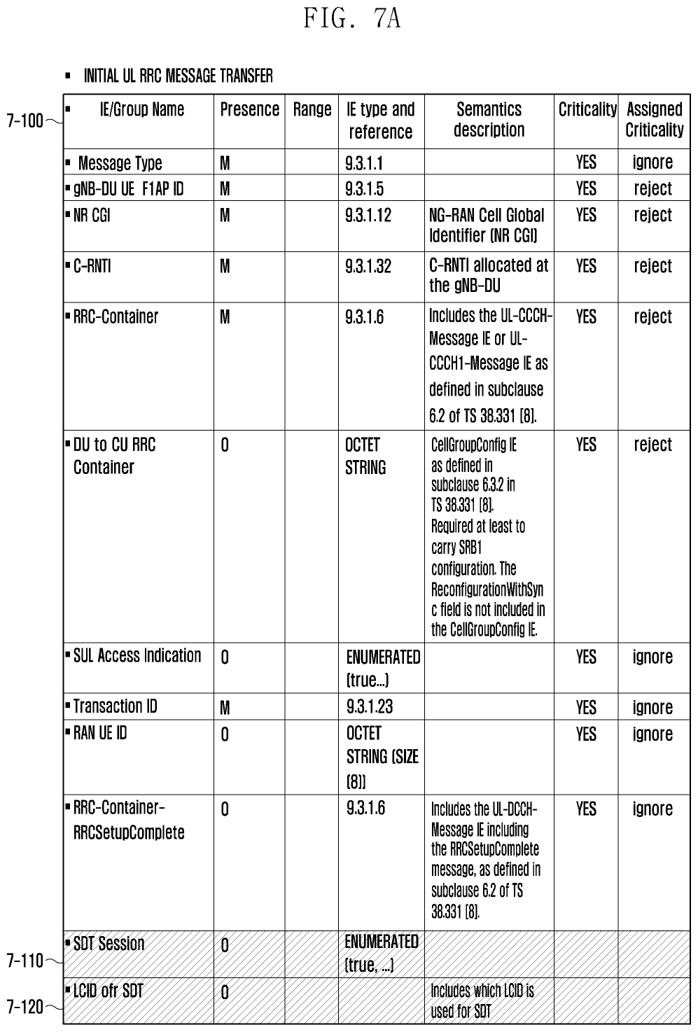

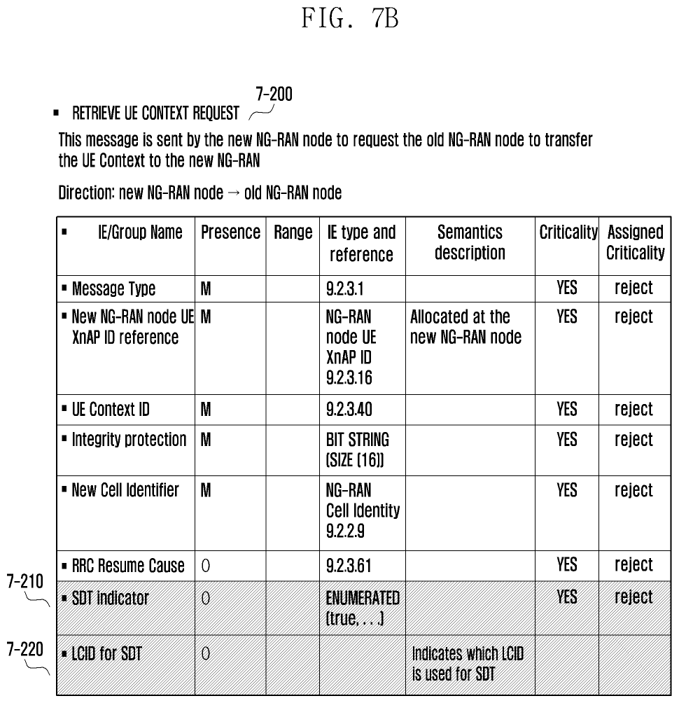

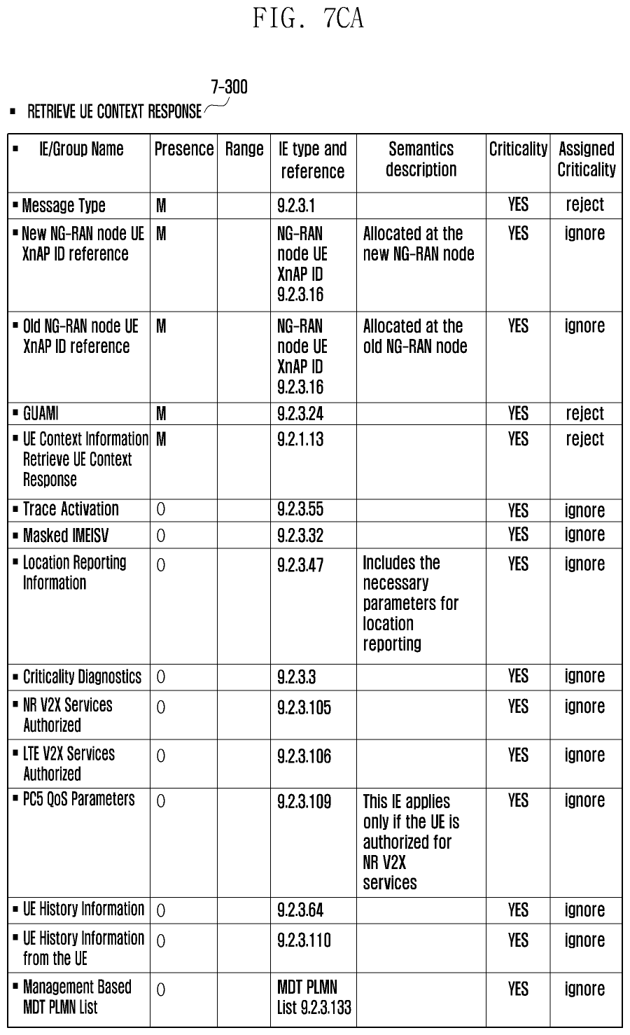

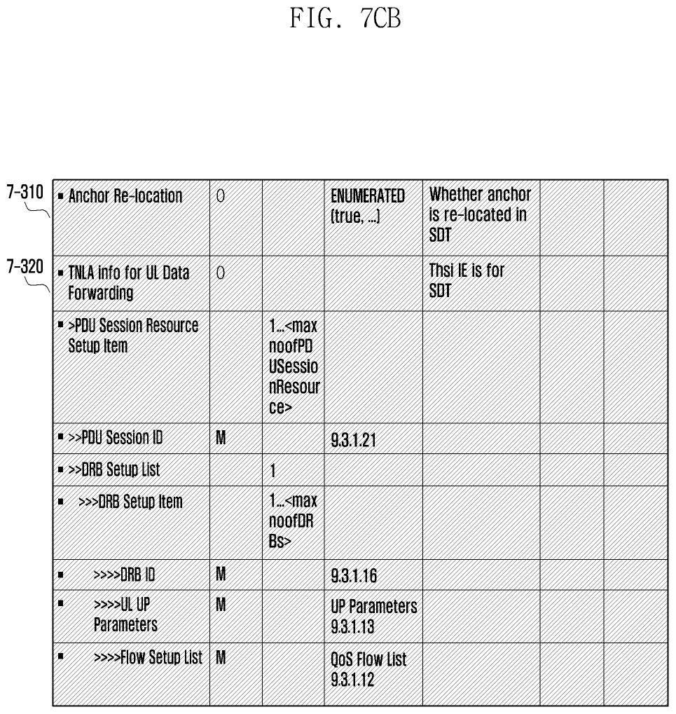

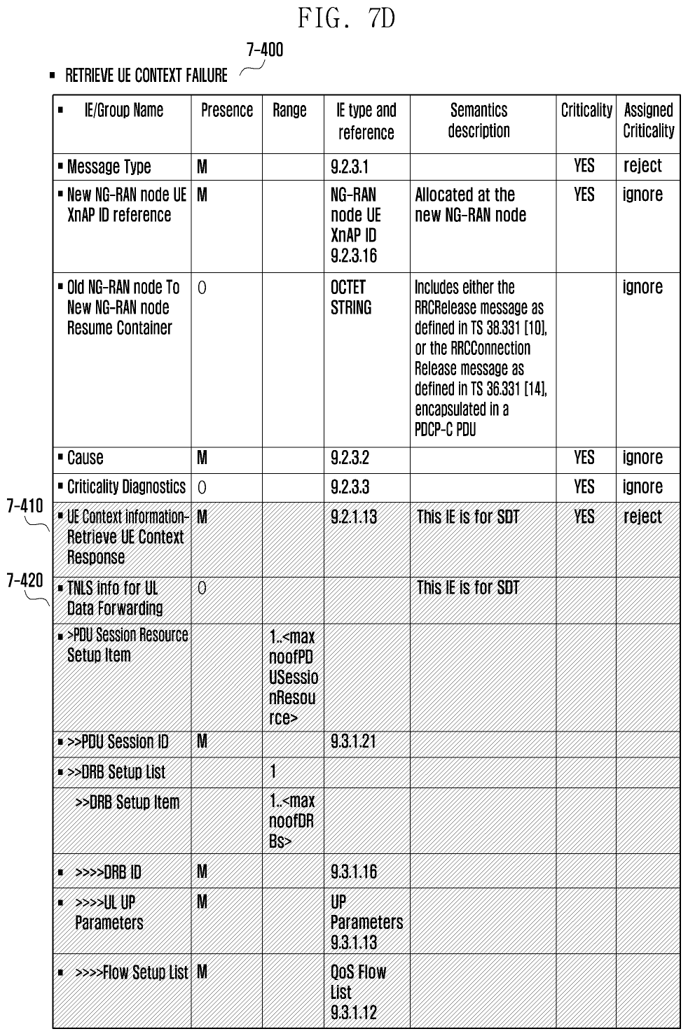

FIGS. 7A, 7B, 7CA, 7CB, and 7D are diagrams illustrating messages and information elements (IEs) according to an embodiment of the disclosure.

In the message (e.g. an INITIAL UL RRC MESSAGE TRANSFER message) 7-100 that the gNB-DU transmits to transfer the RRC message received from the UE to the gNB-CU-CP, at least one of information or IE (e.g., SDT session) 7-110 to indicate that the RRC message transmitted by the UE is for SDT and information or IE (e.g., LCID for SDT) 7-120 to indicate the LCID used to transmit the UL data may be included. According to an embodiment, if the SDT Session in the INITIAL UL RRC MESSAGE TRANSFER received by the gNB-CU-CP is configured to true, the message is recognized as the RRC message for SDT and the UE context related to the DRB corresponding to the LCID for SDT may be set up.

In the message (e.g. a RETRIEVE UE CONTEXT REQUEST message) 7-200 transmitted by the gNB to request UE Context information from the last serving gNB, at least one of information or IE (e.g. SDT Indicator) 7-210 to indicate that the corresponding request is for SDT and information or IE (e.g., LCID for SDT) 7-220 to indicate the LCID used to transmit UL small data may be included. According to an embodiment, if the SDT Indicator in the RETRIEVE UE CONTEXT REQUEST received by the last serving gNB is configured to true, the message is recognized as the request for SDT and a RETRIEVE UE CONTEXT RESPONSE message or RETRIEVE UE CONTEXT FAILURE message may be transmitted to the gNB depending on whether to perform the anchor re-location as follows. Additionally, only the UE Context related to the DRB that matches the LCID for SDT can be selected and delivered to the gNB.

As described above, in case that the last serving gNB receives the RETRIEVE UE CONTEXT REQUEST message from the gNB, the last serving gNB may transmit a response message (e.g., a RETRIEVE UE CONTEXT RESPONSE message 7-300 or a RETRIEVE UE CONTEXT FAILURE message 7-400) in response to the RETRIEVE UE CONTEXT REQUEST message.

Through the RETRIEVE UE CONTEXT REQUEST message 7-300, whether to perform the anchor re-location may be communicated to the gNB using Anchor re-location IE 7-310. Also, in case that the anchor re-location is configured to false, that is, in case that the anchor is maintained without being changed, the UL UP TNLA information of each DRB for data forwarding may be transferred to the gNB 7-320.

The RETRIEVE UE CONTEXT FAILURE message 7-400 may be transmitted to the gNB in case that the anchor is not changed, and the corresponding message may include the UE Context 7-410 required for the gNB to transfer the UL data to the last serving gNB and the UL UP TNLA information 7-420 of each DRB.

Meanwhile, the above-described information does not necessarily have to be all included in one message, and only some part of the information may be included, or other information may be included. Additionally, each piece of information may be transmitted through a separate message.

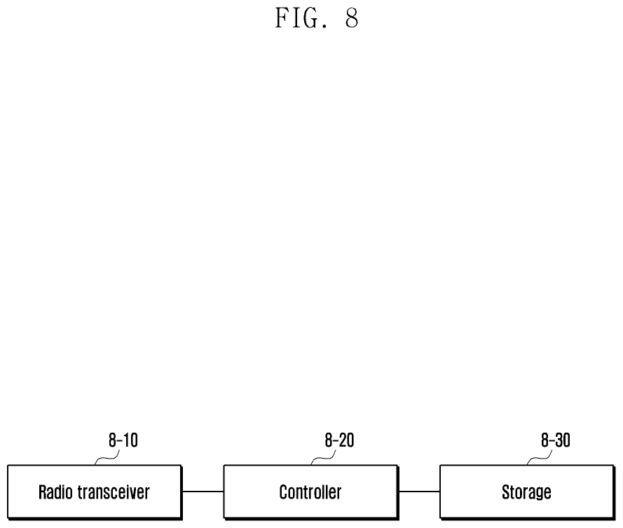

FIG. 8 is a diagram illustrating a structure of a UE according to an embodiment of the disclosure.

With reference to FIG. 8, the UE may include a radio transceiver 8-10, a controller 8-20, a storage 8-30. In the disclosure, the controller may be defined as a circuit, an application-specific integrated circuit, or at least one processor.

The radio transceiver 8-10 may transmit and receive a signal to and from other network entity. For example, the radio transceiver 8-10 may receive a signal from the base station and may transmit a signal including an RRC ResumeRequest message or small-sized UL data (SDT UL data) to the base station. The radio transceiver 8-10 may also be defined as a transceiver or transmitter.

The controller 8-20 may control the overall operation of the UE, according to the embodiment proposed by the disclosure. For example, the controller 8-20 may control the signal flow between the respective blocks to perform the operations according to the flowchart described above. Specifically, the controller 8-20 may control the operation proposed by the disclosure, such as the operation of transmitting an RRC ResumeRequest message to the gNB-DU according to an embodiment of the disclosure, and the operation of determining the radio access state based on the received RRC Release message.

The storage 8-30 may store at least one of information transmitted and received through the radio-transceiver 8-10 and information generated through the controller 8-20. For example, the storage 8-30 may store the radio access state information and DL data.

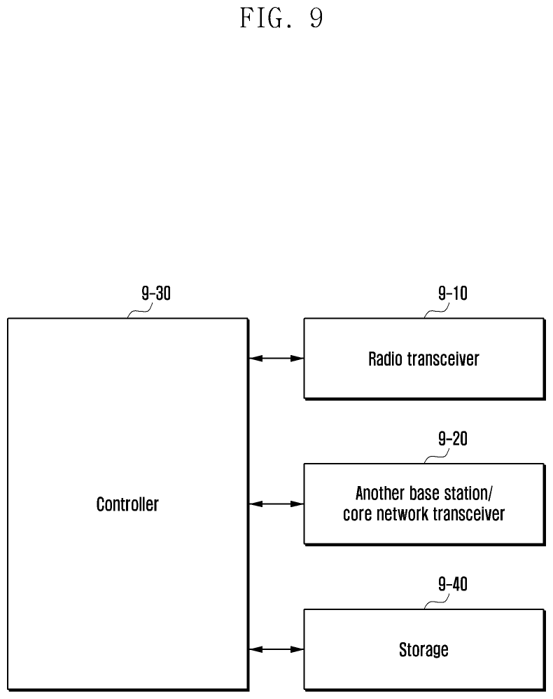

FIG. 9 is a diagram illustrating a structure of a base station according to an embodiment of the disclosure.

Referring With reference to FIG. 9, the base station may include a radio transceiver 9-10, another base station/core network transceiver 9-20, a controller 9-30, and a storage 9-40. In the disclosure, the controller 9-30 may be defined as a circuit, an application-specific integrated circuit, or at least one processor.

The base station shown in FIG. 9 may be a RAN node including both a gNB-CU and a gNB-DU. The RAN node may refer to a mobile communication base station such as an LTE evolved node B (eNB, eNodeB) or a next generation node B (NR gNB, gNodeB) connected to a mobile communication core network (CN) such as evolved packet core (EPC) or a 5G core network (5GC). In addition, the RAN node may be divided into a centralized unit (CU) and a distributed unit (DU), and the CU may be divided again into a CU-control plane (CP) and a CU-user plane (UP).

According to an embodiment of the disclosure, each RAN Node may be constituted with one or more CU-CPs, one or more CU-UPs, and one or more DUs. In addition, a CU-CP, a CU-UP, and a DU constituting a RAN node may be constituted together. For example, a RAN node may be constituted with a CU, in which a CU-CP and a CU-UP are implemented together, and a DU. In another RAN node, a CU-CP and a DU may be implemented together, and a CU-UP may be constituted separately. Another RAN Node may be constituted in the form of an integrated base station in which a CU-CP, a CU-UP, and a DU are implemented together. A RAN node may also be constituted with any other combination than the above-described examples.

According to an embodiment, a CU and a DU may respectively support each base station functions separately. For example, a CU may support a RRC/PDCP layer, and a DU may support a RLC/MAC/PHY/RF layer. In addition, the CU and the DU may be connected to each other through an interface between functions within a base station, such as a W1 or F1 interface.

According to an embodiment, a CU may be divided into a CU-CP and a CU-UP. For example, a RRC/PDCP (for RRC) layer may be supported in a CU-CP, a PDCP (for user data transmission) layer may be supported in a CU-UP, and the CU-CP and the CU-UP may be connected to each other through an interface between functions within a base station, such as an E1 interface.

According to an embodiment, the base stations may be in an integrated structure or a separate structure, such that connection between integrated structure base stations, between separate base stations, or between an integrated structure base station and a separate structure base station may be made. RAN nodes may be connected to each other via an interface between base stations, such as an X2 or Xn interface. In addition, a RAN node and a core network may be connected through an interface between a base station and a core network, such as an S1 or NG Interface.

The radio transceiver 9-10 may transmit and receive a signal to and from other network entity. For example, the radio transceiver 9-10 may receive a signal from the UE and may transmit a signal including a message such as RRC Release that controls the operation of the UE. The radio transceiver 9-10 may also be defined as a transmitting unit or transmitter.

The other base station/core network transceiver 9-20 may transmit or receive a signal to or from another network entity. For example, the other base station/core network transceiver 9-20 may transmit and receive the SDT UL/DL data exchanged with the UPF. The other base station/core network transceiver 9-20 may also be defined as a transmitting unit or transmitter.

In addition, a transceiving unit or transceiver including the Radio transceiver 9-10 and the other base station/core network transceiver 9-20 may be defined.

The controller 9-30 may control the overall operation of the base station, according to the embodiment proposed by the disclosure. For example, the controller 9-30 may control the signal flow between the respective blocks to perform the operations according to the flowchart described above.

The storage 9-40 may store at least one of information transmitted and received through the radio-transceiver 9-10 and the other base station/core network transceiver 9-20 and information generated through the controller 9-30. For example, the storage 9-40 may store the UL data destined for the UPF.

In the above described specific embodiments of the disclosure, components included in the disclosure are referred to in the singular or plural according to the proposed specific embodiment. However, the singular or plural reference is appropriately selected for convenience of description, the disclosure is not limited to the singular or plural component, and even a component expressed as the singular component may be composed of the plural components, and vice versa.

Meanwhile, the embodiments of the disclosure disclosed in the specification and the drawings are merely examples to provide an easy description of the technical content of the disclosure and help understanding of the disclosure, and are not intended to limit the scope of the disclosure. In other words, it is obvious to those skilled in the art that other modifications based on the technical spirit of the disclosure can be implemented. Also, the respective embodiments may be combined with each other as required to be operated. For example, portions of one embodiment and another embodiment of the disclosure may be combined with each other. Also, the embodiments are applicable to other systems, for example, an LTE system, a 5G or NR system, or the like, and other modifications based on the technical scope of the embodiments can be made.

1. A method of a first base station, comprising:
receiving a radio resource control (RRC) resume message for small data transmission (SDT) from a terminal in an RRC inactive;
transmitting a first message for requesting of a terminal context to a second base station, wherein the first message includes an SDT indicator;
in case that the terminal context is not relocated for the SDT, receiving a second message including partial information of an entire context of the terminal, which is included in the second base station; and
based on the partial information of the second message, transferring uplink data of the terminal to the second base station.

2. The method of claim 1, wherein the partial information includes forwarding information required to transfer the uplink data of the terminal to the second base station.

3. The method of claim 1, further comprising:
in case that the terminal context is relocated for the SDT, receiving a third message including the entire context of the terminal included in the second base station; and
based on the entire context of the third message, transmitting the uplink data of the terminal to a user plane function (UPF) without passing through the second base station.

4. The method of claim 3, further comprising:
based on the third message, transmitting a path switch request message to an access and mobility management function (AMF); and
receiving a path switch request acknowledge message from the AMF.

5. The method of claim 1, further comprising:
receiving a fourth message for releasing the terminal context from the second base station; and
based on a reception of the fourth message, transmitting an RRC release message to the terminal.

6. The method of claim 1, wherein the RRC resume message further includes an uplink SDT, and
wherein the second base station is a last serving base station that stores the terminal context in the RRC inactive.

7. A method of a second base station, comprising:
receiving a first message for requesting a terminal context from a first base station, wherein the first message includes a small data transmission (SDT) indicator for SDT of a terminal in a radio resource control (RRC) inactive;
based on the first message, determining whether to relocate the terminal context;
in case that the terminal context is not relocated for the SDT, transmitting a second message including partial information of an entire context of the terminal, which is included in the second base station, to the first base station; and
in case that the terminal context is relocated for the SDT, transmitting a third message including the entire context of the terminal, which is included in the second base station, to the first base station.

8. The method of claim 7, wherein the partial information includes forwarding information required to transfer the uplink data of the terminal to the second base station, and
wherein the second base station is a last serving base station that stores the terminal context in the RRC inactive.

9. A first base station, comprising:
a transceiver; and
a controller configured to:
receive a radio resource control (RRC) resume message for small data transmission (SDT) from a terminal in an RRC inactive,
transmit a first message for requesting of a terminal context to a second base station, wherein the first message includes an SDT indicator,
in case that the terminal context is not relocated for the SDT, receive a second message including partial information of an entire context of the terminal, which is included in the second base station, and
based on the partial information of the second message, transfer uplink data of the terminal to the second base station.

10. The first base station of claim 9, wherein the partial information includes forwarding information required to transfer the uplink data of the terminal to the second base station.

11. The first base station of claim 9, wherein the controller is further configured to:
in case that the terminal context is relocated for the SDT, receive a third message including the entire context of the terminal included in the second base station; and
based on the entire context of the third message, transmit the uplink data of the terminal to a user plane function (UPF) without passing through the second base station.

12. The first base station of claim 11, wherein based on the third message, the controller is further configured to:
transmit a path switch request message to an access and mobility management function (AMF); and
receive a path switch request acknowledge message from the AMF.

13. The first base station of claim 9, wherein the controller is further configured to:
receive a fourth message for releasing the terminal context from the second base station; and
based on reception of the fourth message, transmit an RRC release message to the terminal.

14. The first base station of claim 9, wherein the RRC resume message further includes an uplink SDT.

15. A second base station, comprising:
a transceiver; and
a controller configured to:
receive a first message for requesting a terminal context from a first base station, wherein the first message includes a small data transmission (SDT) indicator for SDT of a terminal in a radio resource control (RRC) inactive,
based on the first message, determine whether to relocate the terminal context,
in case that the terminal context is not relocated for the SDT, transmit a second message including partial information of an entire context of the terminal, which is included in the second base station, to the first base station, and
in case that the terminal context is relocated for the SDT, transmit a third message including the entire context of the terminal, which is included in the second base station, to the first base station.
